(19) United States
(12) Patent Application Publication
(10) Pub. No.: US 2012/0163609 A1
(43) Pub. Date: Jun. 28, 2012

(54) APPARATUS FOR PROCESSING A MULTI-CHANNEL AUDIO SIGNAL AND METHOD THEREOF

(75) Inventors: Tae Jin LEE, Daejeon (KR); Kyeong Ok Kang, Daejeon (KR); Jin Woong Kim, Daejeon (KR); Chang Soo Lim, Seoul (KR)

(73) Assignees: NSONIX Inc., Seoul (KR); Electronics and Telecommunications Research Institute, Daejeon (KR)

(21) Appl. No.: 13/335,171

(22) Filed: Dec. 22, 2011

(30) Foreign Application Priority Data
Dec. 23, 2010 (KR) 10-2010-0134092

(51) Int. Cl. H04R 5/00; G06F 17/00

(52) U.S. Cl. 381/23; 700/94

(57) ABSTRACT

A multi-channel audio signal transmitting apparatus of the present invention includes an encoding unit configured to encode a predetermined audio signal and a controller configured to transmit the encoded audio signal to a predetermined device based on an HDAI (high definition audio interface) protocol.

### CROSS-REFERENCE TO RELATED APPLICATIONS

This application claims priority to and the benefit of Korean Patent Application No. 10-2010-0134092 filed in the Korean Intellectual Property Office on Dec. 23, 2010, the entire contents of which are incorporated herein by reference.

### TECHNICAL FIELD

The present invention relates to an apparatus for processing a multi-channel audio signal that transmits/receives an HD level or higher uncompressed multi-channel audio signal and a method thereof.

### BACKGROUND ART

A multi-channel audio signal processing apparatus transmits a multi-channel audio signal to a certain device that is wired or wirelessly connected thereto, or receives a multi-channel audio signal transmitted from the device.

In the above-mentioned multi-channel audio signal processing apparatus, except an Ethernet method, there is no protocol that transmits/receives 8 channels or more of an HD level uncompressed multi-channel audio signal to/from a single cable using a general purpose cable. As a multi-channel transmission protocol, even though there are 8 channel ADAT and a TDM/I8S, the channel is limited and only two channel stereo is available at an HD level of 24 bits at 192 kHZ. The above protocol does not support bidirectional communication.

### SUMMARY OF THE INVENTION

The present invention has been made in an effort to provide an apparatus for processing a multi-channel audio signal that transmits an HD level uncompressed multi-channel audio signal using a general purpose multimedia cable such as an HDMI cable and a method thereof. The present invention provides an apparatus for processing a multi-channel audio signal that provides an 8 channels or more bidirectional 24 bit audio signal transmission protocol and a transmission method using a general purpose multimedia cable and a method thereof.

An exemplary embodiment of the present invention provides a multi-channel audio signal processing apparatus in a multi-channel audio signal transmitting apparatus, including: an encoding unit configured to encode a predetermined audio signal; and a controller configured to transmit the encoded audio signal to a predetermined device based on an HDAI (high definition audio interface) protocol.

The encoded audio signal may be 24 bits or 32 bits.

The number of channels that is supported by the HDAI protocol may be determined based on a sampling frequency of the encoded audio signal.

The HDAI protocol may include a word clock, a sample clock, data output, and data input.

The word clock may have the same clock frequency as a sampling frequency of the encoded audio signal.

A value of the word clock may be 0 (low) at first channel to N/2 channels, and 1 (high) at (N/2+1) channels to N channels (here, N is the number of total channels).

The sample clock may have one clock frequency of one clock per one bit of the encoded audio signal.

The sample clock may have available data at a rising clock.

The frequency of the sample clock may be a value obtained by multiplying the number of bits per channel, the number of total channels, and the sampling frequency of the encoded audio signal.

The data output may provide any one of 16 bits, 24 bits, and 32 bits per channel.

The data input may provide any one of 16 bits, 24 bits, and 32 bits per channel.

The controller may transmit the encoded audio signal to the predetermined device through an HDMI (high definition multimedia interface) based on the HDAI protocol.

The HDMI may transmit the encoded audio signal using a differential signal method.

Another exemplary embodiment of the present invention provides a multi-channel audio signal processing apparatus that provides bidirectional communication and transmits a 24 bit audio signal of a multichannel of 32 to 64 channels, including: a controller configured to transmit an audio signal to a predetermined device through an HDMI based on an HDAI protocol.

Yet another exemplary embodiment of the present invention provides a multi-channel audio signal transmitting method, including: encoding a predetermined audio signal; and transmitting the encoded audio signal to a predetermined device based on an HDAI protocol.

Still another exemplary embodiment of the present invention provides the multi-channel audio signal transmitting method, including: transmitting the encoded audio signal to the predetermined device through the HDMI cable based on the HDAI protocol.

Exemplary embodiments of the present invention have the following advantages:

First, a multi-channel audio signal can be bidirectionally transmitted and received using an HDAI protocol.

Second, an HD level uncompressed multi-channel audio signal can be transmitted and received suing a general purpose multimedia cable such as an HDMI cable.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a multi-channel audio signal processing apparatus according to an exemplary embodiment of the present invention.

FIG. 2 is a diagram illustrating an HDAI protocol according to an exemplary embodiment of the present invention.

FIG. 3 is a diagram illustrating pins of an HDMI cable according to an exemplary embodiment of the invention.

FIG. 4 is a flow chart illustrating a multi-channel audio signal processing method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawings.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

Exemplary embodiments of the present invention may be implemented by various means. For example, the exemplary embodiments of the present invention may be implemented firmware, software, or a combination thereof, or the like.

In the implementation by the hardware, a method according to exemplary embodiments of the present invention may be implemented by application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the implementation using the firmware or the software, a method according to exemplary embodiments of the present invention may be implemented by modules, procedures, functions, or the like, that perform functions or operations described above. Software codes are stored in a memory unit and may be driven by a processor. The memory unit is disposed in or out the processor and may transmit and receive data to and from the well-known various units.

Throughout the specification, when a predetermined portion is described to be “connected to” another portion, it includes a case where the predetermined portion is electrically connected to the other portion by disposing still another predetermined portion therebetween, as well as a case where the predetermined portion is directly connected to the other portion. Also, when the predetermined portion is described to include a predetermined constituent element, it indicates that unless otherwise defined, the predetermined portion may further include another constituent element, not precluding the other constituent element.

Also, the term module described in the present specification indicates a single unit to process a predetermined function or operation and may be configured by hardware or software, or a combination of hardware and software.

Specific terms are provided to help understandings of the present invention. The use of the specific terms may be changed into other forms without departing from the technical idea of the present invention.

The exemplary embodiment of the present invention relates to an apparatus for processing a multi-channel audio signal that transmits/receives an HD level or higher uncompressed multi-channel audio signal. The exemplary embodiment provides a transmission protocol and a transmission method for a multi-channel audio signal and transmits/receives an HD level uncompressed multi-channel audio signal using a general purpose multimedia cable.

Hereinafter, exemplary embodiments of the present invention will be described in detail with reference to the accompanying drawings.

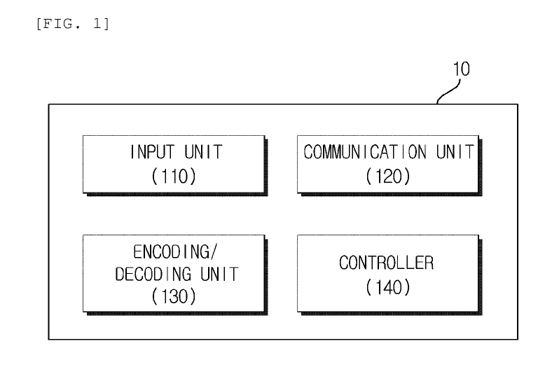

FIG. 1 is a block diagram illustrating a multi-channel audio signal processing apparatus 10 according to an exemplary embodiment of the present invention.

The multi-channel audio signal processing apparatus 10 according to an exemplary embodiment of the present invention includes an input unit 110, a communicating unit 120, an encoding/decoding unit 130, and a controller 140.

The input unit 110 according to the exemplary embodiment of the present invention may include at least one microphone (not shown) that receives an audio signal and/or at least one camera (not shown) that receives a video signal. The input unit 110 receives a predetermined sound signal (or sound information) and/or a voice signal of a user (or voice information of a user) through the microphone.

The microphone receives an external sound signal (including voice (voice signal or voice information) of a user) in a call mode, a recording mode, a voice recognition mode, a video conference mode, and a video phone mode to process the external sound signal as electrical voice data. The processed voice data (for example, including electrical voice corresponding to the sound signal, the voice signal or a TV audio signal) may be output through the speaker (not shown) or converted into a signal that is transmittable to be output to an external terminal through the communicating unit 120.

The camera processes an image frame such as a still image (including a gif format or a jpeg format) or a dynamic image (including a wma format, an avi format, or an asf format) obtained by an image sensor (a camera module or a camera) in the video phone mode, a capturing mode, or a video conference mode. That is, the camera encodes the corresponding image data that is obtained by the image sensor in accordance with CODEC so as to comply with the standards. The processed image frame may be displayed on a display unit (not shown) by control of the controller 140. For example, the camera captures an object (or a subject) (a user image), and outputs a video signal corresponding to the captured image (an image of a subject). The image frame processed in the camera may be stored in a storing unit (not shown) or transmitted to a predetermined external terminal that is connected through the communicating unit 120 so as to communicate with each other.

That is, the input unit 110 receives multimedia information through the microphone and/or the camera. Here, the multimedia information (or data stream) includes sound information or voice information that is received through the microphone and video information/image information (including a still image or a dynamic image) that is received (or captured) by the camera.

The communicating unit 120 according to the exemplary embodiment of the present invention includes a wired/wireless communication network for transmitting/receiving predetermined information to/from a predetermined external terminal (or external equipment). The communicating unit 120 may include a module for wireless Internet access or a module for short range communication. Here, the wireless Internet technology includes a WLAN (wireless LAN), a Wibro (wireless broadband), a Wi-Fi, a Wimax (world interoperability for microwave access), an HSDPA (high speed downlink packet access), and the like. The short range communication technology may include a Bluetooth, a ZigBee, a UWB (ultra wideband), an RFID (radio frequency identification), an IrDA (infrared data association), and the like. A wired communication technology may include a USB (universal serial bus) communication, and the like.

The communicating unit 120 includes an interface module that transmits/receives predetermined information to/from a predetermined external terminal.

The interface module according to the exemplary embodiment of the present invention serves as an interface with all external equipment that is connected to the multi-channel audio signal processing apparatus 10. For example, the interface module may be configured by a wired/wireless headset port, an external charger port, a wired/wireless data port, a memory card port, a port that connects a device including an identification module, an audio I/O (input/output) port, a video I/O (input/output) port, an earphone port, and the like. Here, the identification module refers to a chip in which various information for verifying authorization to use the multi-channel audio signal processing apparatus 10 is stored, and includes a UIM (user identify module), a SIM (subscriber identification module), a USIM (universal subscriber identification module), or the like. A device including the identification module (hereinafter, referred to as an identification device) may be manufactured in the form of a smart card. Therefore, the identification module may be connected to the multi-channel audio signal processing apparatus 10 through the port. The interface module described above receives data or power from the external equipment to transmit the data or power to the respective components provided in the multi-channel audio signal processing apparatus 10 or transmits the data in the multi-channel audio signal processing apparatus 10 to the external equipment. Here, the external equipment (or external device) may be any one of various terminals such as a set-top box, a DVD player, a monitor/speaker, a mobile terminal, a portable terminal, a smart phone, a telematics terminal, a notebook computer, a PDA (personal digital assistant), a Wibro terminal, a digital broadcasting terminal, an IPTV (Internet protocol television) terminal, a television, a 3D television, a PMP (portable multimedia player), an AVN (audio video navigation) terminal, a navigation terminal, an A/V (audio/video) system, and the like.

When the multi-channel audio signal processing apparatus 10 is connected to an external cradle, the interface module may be a channel through which a power supply from the cradle is supplied to the multi-channel audio signal processing apparatus 10 or a channel through which various command signals input through the cradle by a user are transmitted to the multi-channel audio signal processing apparatus 10. The various command signals or the power supply input from the cradle may be operated as a signal for perceiving that the multi-channel audio signal processing apparatus 10 is accurately mounted in the cradle.

The encoding/decoding unit 130 according to the exemplary embodiment of the present invention encodes the video signal (or video data) received through the camera included in the input unit 110 and outputs the encoded video data.

The encoding/decoding unit 130 encodes the audio signal (or audio data) received through the microphone included in the input unit 110 and outputs the encoded audio data. In this case, the encoding process may be performed by using any one of CODECs such as MP3, AC3 (audio coding), AAC (advanced audio coding), WMA (window media audio), OGG (Ogg Vorbis), and the like that are stored in a storing unit (not shown) in advance.

The encoding/decoding unit 130 encodes or decodes a video signal and/or an audio signal included in certain information (or data) received through the communicating unit 120 and outputs the signals.

The controller 140 according to the exemplary embodiment of the present invention transmits the video signal and/or the audio signal encoded by the encoding/decoding unit 130 to a predetermined device connected by the communicating unit 120. The controller 140 outputs the video signal and/or the audio signal decoded by the encoding/decoding unit 130 through a displaying unit (not shown) and/or a speaker (not shown).

The controller 140 transmits the audio signal encoded by the encoding/decoding unit 130 to a predetermined device based on an HDAI (high definition audio interface, hereinafter, referred to as ‘HDAI’) protocol or receives an audio signal transmitted from the predetermined device based on the HDAI protocol.

The HDAI according to the exemplary embodiment of the present invention includes a word clock (hereinafter, referred to as ‘WCLK’), a sample clock (hereinafter, referred to as ‘SCLK’), data output, and data input. The HDAI may transmit/receive not only 24 bits audio signals, but also 32 bits or more audio signals.

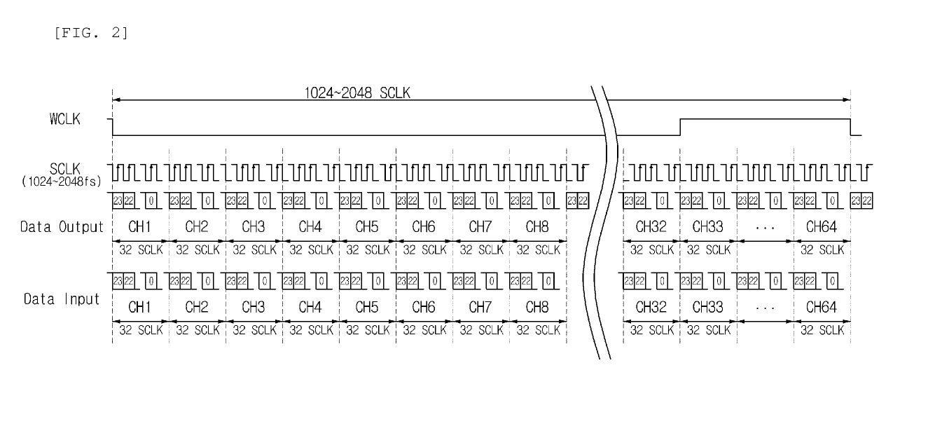

As shown in FIG. 2, the HDAI separates the input/output signal of the audio data from the WCLK signal and the SCLK signal to transmit and receive the separated signals so as to provide accurate clock transmission and synchronization.

The number of channels that can be supported by using the HDAI protocol according to the exemplary embodiment of the present invention is 64. However, the number may vary depending on the sampling frequency as follows. The number of supportable channels can be extended as necessary so that 64 channels or more can be supported.

That is, if the sampling frequency is 48 kHz or lower, 32 to 64 channels can be supported. If the sampling frequency is 192 kHz or lower, 8 to 16 channels can be supported.

For example, when the HDAI protocol is used, 48 to 64 channels of input and output can be supported at 4 bits 48 kHz. 12 to 16 channels of input and output can be supported at 24 bits 192 kHz.

The WCLK according to the exemplary embodiment of the present invention is the same clock frequency as the audio sampling frequency (a frequency of an audio signal encoded by the encoding/decoding unit 130). The WCLK supports up to 192 kHz.

The WCLK is ‘0’ (low) at one to (the number of total channels/2) channel, and ‘1’ (high) at more than the above channels (for example, (the number of total channels/2)+1 channel to the number of total channels). For example, if the audio sampling frequency is 48 kHz or lower and the number of total channels is 32, the WCLK is ‘0’ at one to 16 channels, and ‘1’ at 17 to 32 channels. In another example, if the audio sampling frequency is 48 kHz and the number of total channels is 64, the WCLK is ‘0’ at one to 32 channels and ‘1’ at 33 to 64 channels.

The SCLK according to the exemplary embodiment of the present invention has one clock frequency per one bit of audio data and data is available at a rising clock.

The frequency of the SCLK is calculated by the following equation.

SCLK frequency=the number of bits per channel×the number of total channels×sampling frequency (fs) [Equation 1]

For example, if the sampling frequency is 48 kHz and the number of channels is 32, the SCLK frequency is calculated as 32 bits×32 channels×48 kHz=49.152 MHz, that is, 1024 fs.

In another example, if the sampling frequency is 48 kHz and the number of channels is 64, the SCLK frequency is calculated as 32 bits×64 channels×48 kHz=98.304 MHz, that is, 2048 fs.

The data output according to the exemplary embodiment of the present invention is an audio data output signal, and supports 16 bits or 24 bits per channel and if it is expanded, the data output can support 32 bits or more.

The data input according to the exemplary embodiment of the present invention is an audio data input signal, and supports 16 bits or 24 bits per channel as same as the data output and if it is expanded, the data input can support 32 bits or more.

The controller 140 uses an HDMI (high definition multimedia interface, hereinafter, referred to as ‘HDMI’) to transmit the audio signal to a predetermined device or receive an audio signal transmitted from the predetermined device. The HDMI does not compress the 5 giga bps digital video signal and/or audio signal but may transmit/receive the signals as they are.

The HDMI according to the exemplary embodiment of the present invention is configured by a differential signal manner to stably transmit the audio signal to a long distance.

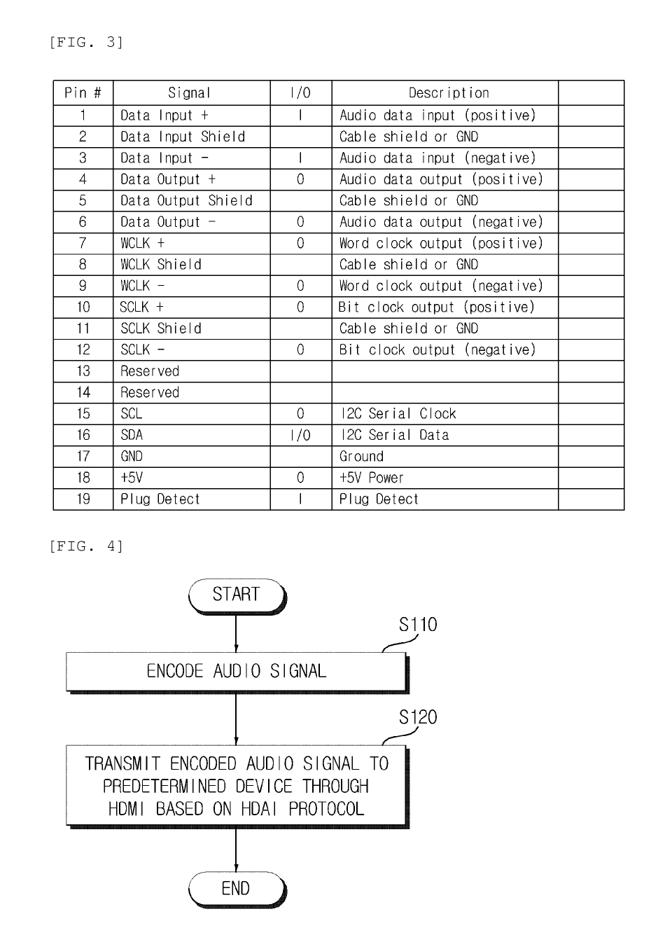

As shown in FIG. 3, the HDMI has terminals for every pin. That is, pin 1 of the HDMI may be a terminal for positive audio data input, pin 2 may be a terminal for cable shield or ground, pin 3 may be a terminal for negative audio data input, pin 4 may be a terminal for positive audio data output, pin 5 may be a terminal for cable shield or ground, pin 6 may be a terminal for negative audio data output, pin 7 may be a terminal for positive WCLK clock output, pin 8 may be a terminal for cable shield or ground, pin 9 may be a terminal for negative WCLK clock output, pin 10 may be a terminal for positive SCLK clock output, pin 11 may be a terminal for cable shield or ground, pin 12 may be a terminal for negative SCLK clock output, pins 13 and 14 may be reserved terminals, pin 15 may be a terminal for an I2C serial clock, pin 16 may be a terminal for I2C serial data, pin 17 may be a terminal for ground, pin 18 may be a terminal for power supply, and pin 19 may be a terminal for plug detection.

Even though the multi-channel audio signal processing apparatus according to the exemplary embodiment of the present invention describes an HDMI type general purpose cable, the invention is not limited thereto, but interconnector (digital/analog interconnect) cable, an optical cable, a coaxial cable, a balanced cable, or the like may be used.

Even though the multi-channel audio signal processing apparatus according to the exemplary embodiment of the present invention describes a wired HDMI, the invention is not limited thereto, but a wireless HDMI or other wire/wireless methods may be used.

The multi-channel audio signal processing apparatus according to the exemplary embodiment of the present invention may expand various bits according to the number of bits to be processed.

FIG. 4 is a flow chart illustrating a multi-channel audio signal processing method according to an exemplary embodiment of the present.

Hereinafter, with reference to FIGS. 1 to 4, the exemplary embodiment will be described.

First, the encoding/decoding unit 130 encodes a predetermined audio signal that is received through the input unit 110 or the communicating unit 120, based on a predetermined sampling frequency (S110).

The controller 140 transmits the audio signal encoded by the encoding/decoding unit 130 to a predetermined communication connected device through the HDMI based on a previously set HDAI protocol.

At this time, the HDAI protocol includes a word clock that has the same clock frequency as the sampling frequency of the encoded audio signal, a sample clock that has one clock frequency per one bit of the encoded audio signal, data output that provides a plurality of bits, and data input that provides a plurality of bits. Here, the frequency of the sample clock is a value obtained by multiplying the number of bits per channel, the number of total channels, and the sampling frequency of the encoded audio signal.

The HDMI transmits the encoded audio signal by the differential signal method to the predetermined communication connected device (S120).

The multi-channel audio signal processing apparatus and method according to the exemplary embodiments can be applied to any field that transmits/receives, for example, a multi-channel audio signal.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A multi-channel audio signal processing apparatus in a multi-channel audio signal transmitting apparatus, comprising:
an encoding unit configured to encode a predetermined audio signal; and
a controller configured to transmit the encoded audio signal to a predetermined device based on an HDAI (high definition audio interface) protocol.

2. The apparatus of claim 1, wherein the encoded audio signal is 24 bits or 32 bits.

3. The apparatus of claim 1, wherein the number of channels that is supported by the HDAI protocol is determined based on a sampling frequency of the encoded audio signal.

4. The apparatus of claim 1, wherein the HDAI protocol includes a word clock, a sample clock, data output, and data input.

5. The apparatus of claim 4, wherein the word clock has the same clock frequency as a sampling frequency of the encoded audio signal.

6. The apparatus of claim 5, wherein a value of the word clock is 0 (low) at first channel to N/2 channels, and 1 (high) at (N/2+1) channels to N channels (here, N is the number of total channels).

7. The apparatus of claim 3, wherein the sample clock has one clock frequency of one clock per one bit of the encoded audio signal.

8. The apparatus of claim 7, wherein the sample clock has available data at a rising clock.

9. The apparatus of claim 8, wherein the frequency of the sample clock is a value obtained by multiplying the number of bits per channel, the number of total channels, and the sampling frequency of the encoded audio signal.

10. The apparatus of claim 3, wherein the data output provides any one of 16 bits, 24 bits, and 32 bits per channel.

11. The apparatus of claim 3, wherein the data input provides any one of 16 bits, 24 bits, and 32 bits per channel.

12. The apparatus of claim 1, wherein the controller transmits the encoded audio signal to the predetermined device through an HDMI (high definition multimedia interface) based on the HDAI protocol.

13. The apparatus of claim 12, wherein the HDMI transmits the encoded audio signal using a differential signal method.

14. A multi-channel audio signal processing apparatus that provides bidirectional communication and transmits a 24 bit audio signal of a multichannel of 32 to 64 channels, comprising:
a controller configured to transmit an audio signal to a predetermined device through an HDMI based on an HDAI protocol.

15. A multi-channel audio signal transmitting method, comprising:
encoding a predetermined audio signal; and
transmitting the encoded audio signal to a predetermined device based on an HDAI protocol.

16. The method of claim 15, wherein the number of channels that is supported by the HDAI protocol is determined based on a sampling frequency of the encoded audio signal.

17. The method of claim 15, wherein the HDAI protocol includes a word clock, a sample clock, data output, and data input.

18. The method of claim 15, wherein the transmitting of the encoded audio signal to a predetermined device includes transmitting the encoded audio signal to the predetermined device through the HDMI based on the HDAI protocol.

19. The method of claim 18, wherein the HDMI transmits the encoded audio signal to the predetermined device by a differential signal method.
